(19) United States
(12) Patent Application Publication
(10) Pub. No.: US 2018/0144345 A1
(43) Pub. Date: May 24, 2018

(54) ASSURANCE EXCHANGE

(71) Applicant: KIM WAGNER, Sunnyvale, CA (US)

(72) Inventor: KIM WAGNER, Sunnyvale, CA (US)

(21) Appl. No.: 15/360,106

(22) Filed: Nov. 23, 2016

(51) Int. Cl. G06Q 20/40; G06Q 30/08; G06F 17/30

(52) U.S. Cl. CPC G06Q 20/4014; G06F 17/30477; G06Q 30/08; G06Q 20/4016

(57) ABSTRACT

Systems and methods for facilitating an exchange of assurance for an individual transaction are disclosed. A method includes receiving an authorization request message for a transaction from an access device, and determining a coverage entity from a plurality of coverage entities for the transaction, the plurality of coverage entities available to provide coverage for the transaction. The method also includes linking, by the server computer, the coverage entity to the transaction, and transmitting, an authorization response message to the access device.

### BACKGROUND

In today's technological environment, authentication data is often intercepted by criminal actors that are able to hack into networks and data systems that receive and send data in a transaction. Once the authentication data has been obtained, the criminal actor may use the data to conduct subsequent transactions and fraudulently obtain resources. In many cases, the authorizing entity involved in such transactions do not realize that the transactions were made using stolen data until after resources have been delivered, in which case, the authorizing entity must cover most or all losses that occur. This may prove to be problematic, as several transactions may occur over a short period of time. Thousands of transactions may be made using stolen data, resulting in significant losses for authorizing entities.

One way to avoid such losses, would be to impose stricter authorization criteria for transactions, in which only transactions deemed to have low risk would be authorized by the authorizing entity. Thus, conventional transaction processing systems may process transaction request messages that are too risky by simply declining them. However, imposing stricter authorization criteria can often lead to many authentic transactions being denied, which is an adverse outcome for all entities involved. Currently in the art, there exists no way to leverage authentication data in a way that provides an optimal balance between minimizing losses and maximizing overall authorizations.

Embodiments of the invention address these and other problems, individually and collectively.

### BRIEF SUMMARY

Embodiments of the invention are directed to systems and methods for facilitating an exchange of liability for an individual transaction.

One embodiment of the invention is directed to a method. The method comprises receiving, by a server computer, an authorization request message for a transaction from an access device, and determining, by the server computer, a coverage entity from a plurality of coverage entities for the transaction, the plurality of coverage entities available to provide coverage for the transaction. The method also includes linking, by the server computer, the coverage entity to the transaction. The method also includes transmitting, an authorization response message, by the server computer, to the access device.

Other embodiments of the invention are directed to one or more server computers, each comprising: a processor, and a computer readable medium comprising code, executable by the processor to implement a method. The method comprises receiving, by a server computer, an authorization request message for a transaction from an access device, and determining, by the server computer, a coverage entity from a plurality of coverage entities for the transaction, the plurality of coverage entities available to provide coverage for the transaction. The method also includes linking, by the server computer, the coverage entity to the transaction. The method also includes transmitting, an authorization response message, by the server computer, to the access device.

These and other embodiments of the invention are described in further detail below.

### BRIEF DESCRIPTION OF THE DRAWINGS

FIG. 1 shows a diagram of a system for facilitating an exchange of liability for an individual transaction according to embodiments of the invention.

FIG. 2 shows a process flow diagram for facilitating an exchange of liability for an individual transaction according to embodiments of the invention.

FIG. 3 shows an example of a buyer/seller table used by a server computer to facilitate an exchange of liability for an individual transaction according to an embodiment of the invention.

FIG. 4 shows a block diagram of an exemplary server computer according to an embodiment of the invention.

### DETAILED DESCRIPTION

Embodiments of the present invention provide techniques for facilitating a real-time exchange of assurance for an individual transaction during the processing of the individual transaction.

Prior to discussing the details of some embodiments of the present invention, description of some terms may be helpful in understanding the various embodiments.

A “portable communication device” may be a device that can be transported and be operated by a user, and may be used to communicate information. A portable communication device according to an embodiment of the invention may be in any suitable form including, but not limited to a mobile phone (e.g., smart phone, cellular phone, etc.), a tablet computer, a portable media player, a personal digital assistant device (PDA), a wearable communication device (e.g., watch, bracelet, glasses, etc.), an electronic reader device, a laptop, a netbook, an ultrabook, etc. A portable communication device may also be in the form of a vehicle (e.g., a car) equipped with communication capabilities.

Portable communication devices according to embodiments of the invention can be configured to communicate with external entities such as remote communication gateways through long range communications technologies and protocols. They may also be configured to communicate with external entities such as access devices using any suitable short or medium range communications technology including Bluetooth™ (classic and BLE—Bluetooth low energy), NFC (near field communications), IR (infrared), Wi-Fi, etc.

A “portable transaction device” may be a device that can be easily transported by a person and that can be used to conduct a transaction. A portable transaction device may include a data store (e.g., electronic memory, magnetic stripe, etc.) to store credentials or tokens associated with an account of a user. A portable transaction device can be in any of the forms described above with respect to the portable communication device, or in the form of a card (e.g., integrated chip card, magnetic stripe card) or a fob, etc. In some embodiments, the portable transaction device and the portable communication device may be the same device, and need not be separate devices. Specific examples of portable transaction devices can include wearable devices, payment cards such as credit, debit, and prepaid cards, vehicles with remote communication capabilities, etc.

A “server computer” may include a powerful computer or cluster of computers. For example, the server computer can be a large mainframe, a minicomputer cluster, or a group of servers functioning as a unit. In one example, a server computer may be a database server coupled to a Web server. A server computer may comprise one or more computational apparatuses and may use any of a variety of computing structures, arrangements, and compilations for servicing the requests from one or more client computers.

An “access device” may be any suitable device for providing access to an external computer system. An access device may be in any suitable form. Some examples of access devices include point of sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a portable communication device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a portable communication device.

An “authorization request message” may be an electronic message that is sent to request authorization for a transaction. The authorization request message can be sent to a payment processing network and/or an issuer of a payment card. An authorization request message according to some embodiments may comply with ISO 8583, which is a standard for systems that exchange electronic transaction information associated with a payment made by a user using a payment device or payment account. The authorization request message may include information that can be used to identify an account. An authorization request message may also comprise additional data elements such as one or more of a service code, an expiration date, etc. An authorization request message may also comprise transaction information, such as any information associated with a current transaction, such as the transaction amount, merchant identifier, merchant location, etc., as well as any other information that may be utilized in determining whether to identify and/or authorize a transaction. The authorization request message may also include other information such as information that identifies the access device that generated the authorization request message, information about the location of the access device, etc.

An “authorization response message” may be an electronic message reply to an authorization request message. The authorization response message can be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant computer that indicates approval of the transaction. The code may serve as proof of authorization.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

A “value credential” may be information associated with worth. Examples of value credentials include payment credentials, coupon identifiers, information needed to obtain a promotional offer, etc. Herein, “value credential” may also refer to a token that may serve as a substitute for a value credential during a transaction.

A “payment credential” may include any suitable credential that can be used to conduct a payment transaction. Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc.

An “application” may be computer code or other data stored on a computer readable medium (e.g. memory element or secure element) that may be executable by a processor to complete a task.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g. a token) that may be associated with the payment account identifier.

A “resource provider” may be an entity that can provide a resource such as goods, services, information, and/or access. Examples of resource providers include merchants (e.g., a supermarket), data providers such as government agencies, transit agencies (e.g., a train station), etc. A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc. An authorizing entity may operate an authorization computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

An “account identifier” may include an identifier for an account. An account identifier may include an original account identifier associated with a payment account. For example, a real account identifier may be a primary account number (PAN) issued by an issuer for a card account (e.g., credit card, debit card, etc.). For instance, in some embodiments, a real account identifier may include a sixteen digit numerical value such as “4147 0900 0000 1234.” The first six digits of the real account identifier (e.g., “414709”), may represent a real issuer identifier (BIN) that may identify an issuer associated with the real account identifier.

“Coverage” or “liability coverage” may relate to a particular amount of assurance that can be provided by an entity. Coverage may be a specific amount of funds such as an amount of funds equal to the amount of a transaction that a coverage entity agrees to cover if the transaction is found to be fraudulent. In some embodiments, “liability coverage” may include insurance, which may be a guarantee of compensation in the event of fraud or loss in return for an exchange of value (e.g., a premium).

A “liability exchange” may be an exchange of responsibility for a particular circumstance. For example, a liability exchange may be an exchange of responsibility for covering the amount of a transaction if the transaction is found to be fraudulent. A liability exchange may involve exchanging coverage of a transaction in exchange for an amount of funds. A liability exchange can be facilitated in a “liability auction” which may involve sending information for a transaction to coverage entities, receiving a bidding price from each coverage entity, selecting the lowest bidding price, facilitating funds between participating parties, and recording a contract for the exchange of liability.

A “key” may refer to a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “cryptographic pattern” may include cryptographically secure data. Examples of cryptographic patterns may include cryptographic hashes, encrypted data, etc.

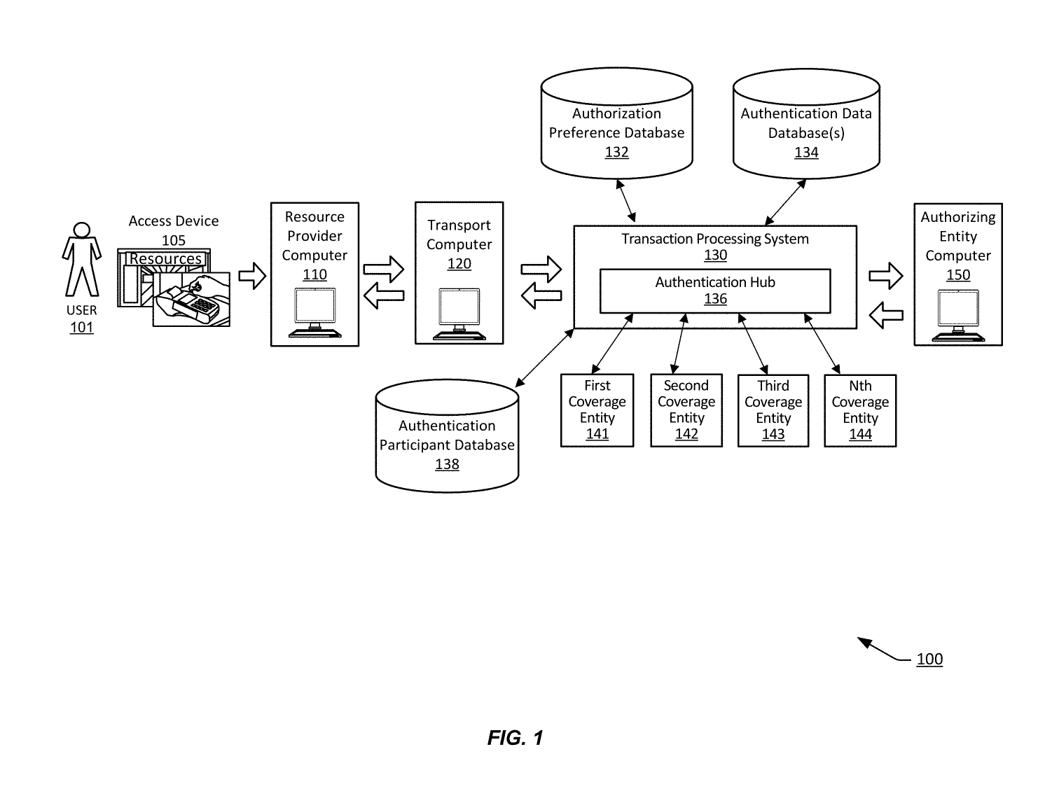

FIG. 1 illustrates a system 100 according to an embodiment of the invention. The system 100 can be used to facilitate an exchange of liability for an individual transaction.

FIG. 1 shows a user 101 that may interact with an access device 105. The access device 105 may be in communication with an authorizing entity computer 150 via a resource provider computer 110, a transport computer 120, and a transaction processing system 130. Each of these computers, systems, and devices is described in further detail below.

The entities in FIG. 1 may communicate using any suitable communications networks. Suitable communications networks may be any one and/or the combination of the following: a direct interconnection; the Internet; a Local Area Network (LAN); a Metropolitan Area Network (MAN); an Operating Missions as Nodes on the Internet (OMNI); mesh networks, a secured custom connection; a Wide Area Network (WAN); a wireless network (e.g., employing protocols such as, but not limited to a Wireless Application Protocol (WAP), I-mode, and/or the like); and/or the like.

System 100 comprises access device 105 that can be configured to conduct a transaction with a resource provider such as a merchant and may be coupled to resource provider computer 110. User 101 may conduct a transaction by causing a portable device that may store and transmit value credentials such as payment account information to interact with the access device 105. For example, user 101 may conduct a transaction with access device 105 by swiping or inserting a payment card that stores payment credentials into access device 105 or by transmitting a payment token wirelessly to access device 105 using a contactless element of a mobile device. Access device 105 may then transmit the payment credentials or payment token to resource provider computer 120 through a connection interface of resource provider computer 120 such as a USB port.

Resource provider computer 110 may be configured to process a transaction by recording and generating transaction data such as a transaction amount and payment account information and using the transaction data to generate an authorization request message. Resource provider computer 120 may be configured to transmit the authorization request message to transport computer 120. Transport computer 120 may be a computer operated by an acquirer. An acquirer may acquire and/or hold payments and/or funds on behalf of the resource provider when a transaction is processed.

Transport computer 120 may be configured to forward the authorization request message to transaction processing system 130. In some embodiments, the transaction processing system 130 may include data processing subsystems, server computers, databases, networks, and operations used to support and deliver authorization services, exception file services, transaction scoring services, and clearing and settlement services. An exemplary transaction processing system may include VisaNet™. Transaction processing systems such as VisaNet™ are able to process credit card transactions, debit card transactions, and other types of commercial transactions. VisaNet™, in particular, may include a VIP system (Visa Integrated Payments system) which processes authorization requests and a Base II system which performs clearing and settlement services.

Transaction processing system 130 may be further configured to receive the authorization request message and determine an authorizing entity or issuer associated with the value credentials or payment account information contained in the authorization request message. For example, transaction processing system 130 may be configured to read account information contained in the authorization request message and may determine that the account information comprises a 16-digit primary account number (PAN) and may determine that the first 4 digits of the PAN are associated with a specific issuer or bank. Transaction processing system 130 may also be configured to access authorization preference database 132 to retrieve the authorization preferences of the authorizing entity.

Transaction processing system 130 may further be configured to retrieve the authorization preferences of the authorizing entity and may compare the authorization preferences to the transaction data contained in the authorization request message to determine if transaction processing system 130 should facilitate an exchange of liability coverage for the transaction. For example, transaction processing system 130 may be configured to determine from the authorization preferences retrieved from authorization preference database 132 that only transactions for an amount greater than $500 should be sent to a liability exchange. Transaction processing system 130 may also be configured to read the transaction amount contained in the authorization request message and may determine that the transaction amount is equal to $550 and may then begin an exchange of liability coverage for the transaction.

In one embodiment, transaction processing system 130 may be configured to determine based on the retrieved authorization preferences that a risk score should be assigned to the transaction and may use data stored in one or more authentication data database(s) 134 to assess the risk of the transaction and generate a risk score. For example, transaction processing system 130 may be configured to compare the transaction data such as a merchant ID and payment account information to a list of merchant IDs and payment account information marked as fraudulent in the one or more authentication data database(s) 134. The transaction processing system 130 be configured to determine, using an appropriate risk scoring module (which may be a fraud determination algorithm) and a processor, if the transaction data is directly or indirectly related to any known fraudulent activity. In some embodiments, the transaction processing system 130 may also be configured to quantify how closely related the transaction data is related to the known fraudulent activity by generating a score ranging from 0 to 100. Authentication data database(s) 134 may additionally store data about user 101 (or an account of the user 101) that may be used to assess the risk of the transaction such as spending habits and credit worthiness. Each authentication data database in the one or more authentication data database(s) 134 may store disparate authentication data.

The transaction processing system 130 can be configured to, upon determining an exchange of liability coverage can be facilitated for the transaction, send the transaction to authentication hub 136. Authentication hub 136 may be one or more computers managed by transaction processing system 130 (or may be external to the transaction processing system 130) that connects authentication participants. For example, authentication hub 136 may be a network that connects suppliers of authentication services (e.g. risk evaluation, biometric authentication services, authentication data services, etc.) to authorizing entities that may use the authentication services. In one embodiment of the invention, the supplier of authentication services may be a supplier of liability coverage for an individual transaction and the authorizing entity may be an issuer that wishes to purchase the liability coverage.

Transaction processing system 130 may also be configured to use authentication hub 136 to provide the authentication participants with data based on a data subscription in which the authentication participants have enrolled. The data subscription may grant an authentication participant access to a specific set of data provided by a third-party provider of authentication data, by transaction processing system 130, or by a supplier of authentication services. Examples of providers of authentication data may include Lexis Nexus, Equifax, Neustar, etc. According to one embodiment, the specific set of data may be data stored in the one or more authentication data database(s) 134. For example, the authentication participants may include suppliers of liability coverage (e.g. first coverage entity 141 such as a first insurer, second coverage entity 142 such as a second insurer, etc.). These suppliers of liability coverage may be subscribed to receive a set of data relating to fraud associated with a specific merchant. First coverage entity 141 may receive a set of data from Lexis Nexus, while second coverage entity 142 may receive a different set of data from Equifax. Transaction processing system 130 may query authentication participant database 138 to determine the data subscriptions of the authentication participants and retrieve the sets of data from the one or more authentication data database(s) via authentication hub 136. The sets of data can then be received by first coverage entity 141 and second coverage entity 142. First coverage entity 141 and second coverage entity 142 may each use the received sets of data to assess risk and make a decision to provide liability coverage for an individual transaction as the individual transaction is being processed.

Transaction processing system 130 may be configured to manage data subscriptions for authentication participants in authentication participant database 138. Authentication participant database 138 may also comprise preferences or conditions specific to each authentication participant that may be used by transaction processing system 130. For example, authentication participant database 138 may store conditions under which a specific supplier of liability coverage is willing to supply coverage for an individual transaction (e.g. for transactions with a transaction amount greater than $500 and a risk score less than 50). The transaction processing system 130 may use this information to determine if the specific supplier of liability coverage should be selected for participation in a liability auction regarding the individual transaction.

According to some embodiments of the invention, authentication participants may be buyers and sellers of liability coverage in a liability auction. A buyer of liability coverage may be an authorizing entity such as an authorizing entity of authorizing entity computer 150. A buyer of liability coverage may also be an acquirer of transport computer 120 or a resource provider of resource provider computer 110. The buyer of liability coverage may choose to purchase liability coverage for an individual transaction if, based on authentication data, the buyer of liability determines that it is advantageous to shift the risk associated with the transaction onto another entity in exchange for a reasonable amount of currency.

A seller of liability coverage, according to embodiments of the invention, may be a coverage entity that is willing to provide coverage for an individual transaction such as first coverage entity 141, second coverage entity 142, third coverage entity 143, and/or nth coverage entity 144. For example, a seller of liability coverage may be a coverage entity that provides insurance covering the value of resources provided in a transaction if the transaction is later found to be fraudulent.

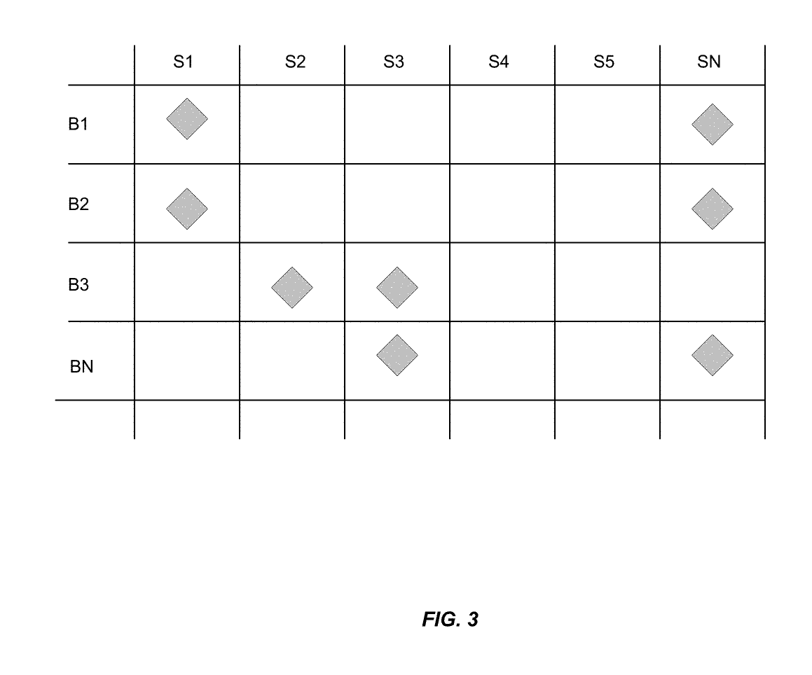

In one embodiment, authentication participant database 138 may comprise a database table that stores predetermined conditions for when buyers and sellers of liability coverage are willing to participate in an exchange of liability for an individual transaction that is being processed. With reference to FIG. 3, authentication participant database 138 may comprise of a database table in which specific buyers of liability coverage are placed in rows and specific suppliers of liability coverage are placed in columns. Each entry in the database table may be predetermined conditions that each buyer of liability coverage has set for a specific supplier of liability coverage, and vice versa (e.g. “only exchange liability for buyer 1 if risk score is below 50”). During an individual transaction, transaction processing system 130 may then query the database table for entries containing predetermined conditions that the transaction satisfies (e.g. risk score below 50, risk score below 60, etc.). The database may include a table identifying buyers and sellers that would be willing to participate in an exchange of liability for the transaction. Transaction processing system 130 may then determine the authentication participants that are linked to those entries and may facilitate an exchange of liability for the individual transaction in a liability auction involving the determined authentication participants.

For example, transaction processing system 130 may receive a transaction involving an individual attempting to purchase a television for $500. The transaction processing system 130 may also determine that the merchant location at which the purchase is being attempted has no history of fraudulent activity and assesses a risk score of 10 or “low risk” to the transaction. The transaction processing system 130 may then match the transaction data (e.g. transaction amount, risk score, etc.) to a buyer/seller table in authentication participant database 138 and determine that Bank of America wishes to insure all transactions above $200 and that Berkshire Hathaway is willing to provide insurance for all individual transactions with a risk score below 50. Transaction processing system 130 may then facilitate an exchange of liability insurance in which Bank of America transfers the liability or risk associated with the transaction to Berkshire Hathaway in exchange for a reasonable amount of money (e.g. $5). Later after the transaction has been processed, if the transaction was found to be made fraudulently using a stolen credit card, Berkshire Hathaway would be held liable for covering the associated losses (i.e. Berkshire Hathaway would owe either Bank of America, the merchant, the merchant's bank, or the owner of the stolen credit card $500). In one embodiment, the covered losses and exchange of funds may be managed by transaction processing system 130 in a dispute resolution process.

Returning to FIG. 1, transaction processing system 130 may compare the transaction data in the authorization request message against authentication participant database 138 and determine that first coverage entity 141, second coverage entity 142, third coverage entity 143, and Nth coverage entity 144 may supply liability coverage for the transaction. Transaction processing system 130 may then transmit the transaction data to first coverage entity 141, second coverage entity 142, third coverage entity 143, and Nth coverage entity 144 along with specific authentication data related to the transaction based on each of coverage entity's data subscription. For example, transaction processing system 130 may transmit the transaction data and a credit score for user 101 to first coverage entity 141 and may transmit the transaction data and a fraud profile for resource provider computer 110 to second coverage entity 142. The same or different types of authentication data may be sent to the various coverage entities 141, 142, 143, 144.

After transmitting the transaction data and specific authentication data to first coverage entity 141, second coverage entity 142, third coverage entity 143, and Nth coverage entity 144, each coverage entity may determine a bidding value for the transaction based on the transaction data and specific authentication data. The bidding value may be a price that a coverage entity may request from an authorizing entity in exchange for covering the transaction amount if the transaction is later found to be fraudulent. For example, first coverage entity 141 may determine that the bidding value for the transaction is $15. In exchange for this money, the first coverage entity 141 may be willing to accept responsibility for covering the transaction amount if the transaction is later found to be fraudulent.

After each coverage entity has determined a bidding value for the transaction, each coverage entity may submit their bidding values to transaction processing system 130. Transaction processing system 130 may receive each bidding value from each coverage entity and may determine a lowest bidding value as well as a coverage entity linked to the lowest bidding value. For example, transaction processing system 130 may receive a bidding value of $15 from first coverage entity 141, a bidding value of $12 from second coverage entity 142, a bidding value of $10 from third coverage entity 143, and a bidding value of $17 from Nth coverage entity 144. Transaction processing system 130 may then determine that the lowest bidding value is $10 and is linked to third coverage entity 143.

Upon determining the lowest bidding value and the coverage entity linked to the lowest bidding value, transaction processing system may store a record of the determination in authentication participant database 138. For example, the record of the determination may comprise of a transaction ID for the transaction, an indication of an authorizing entity and a coverage entity involved in the transaction, as well as a contract describing terms agreed to between the authorizing entity and the coverage entity regarding the transaction. The record of the determination may be later accessed by transaction processing system 130 to facilitate funds and settle disputes if the transaction is later found to be fraudulent. In some embodiments, the database 138 may be implemented in the form of a centralized or distributed blockchain.

After storing a record of the determination, transaction processing system 130 may transmit the authorization request message to authorizing entity computer 150 so that it may authorize the transaction. In one embodiment, authorizing entity computer 150 may only authorize the transaction if transaction processing system 130 was able to find a coverage entity willing to cover the transaction or if transaction processing system 130 received a lowest bidding price below a specified value (e.g. below $12). In another embodiment, transaction processing system 130 may submit the authorization request message to authorizing entity computer 150 for authorization without facilitating an exchange of liability initially and may instead facilitate the exchange of liability coverage after the authorizing entity computer 150 has authorized the transaction.

Once authorizing entity computer 150 has received the authorization request message from transaction processing system 130, authorizing entity computer 150 may approve or decline the transaction based on the transaction data. For example, authorizing entity may approve or decline the transaction based on an availability of funds or based on an assessment of risk associated with the transaction. Authorizing entity computer 150 may then generate an authorization response message comprising the transaction data as well as an indication of approval or decline. Authorizing entity computer 150 may then send the authorization response message to transaction processing system 130. Transaction processing system 130 may then transmit the authorization response message to transport computer 120 which may then forward the authorization response message to resource provider computer 110 to complete the transaction.

At the end of the day or at some other period of time, a clearing and settlement process can take place.

Embodiments of the invention provide a number of advantages over prior art. Embodiments of the invention allow for an authorizing entity computer to authorize a higher volume of authentic transactions over prior authorization and authentication systems as the risk associated with each transaction has been shifted to a coverage entity that is willing to accept liability. In other words, transactions that might have otherwise been declined may be accepted since a coverage entity other than the authorizing entity is willing to assume the risk of the transaction failing (e.g., due to fraud). Furthermore, embodiments of the invention allow an authorizing entity to optimize its authorization process and incur minimal losses as the risk for each individual transaction is evaluated by a plurality of competing coverage entities based on a plurality of disparate authentication data. An authorizing entity is able to select the most favorable coverage policy based on such factors as lowest bidding value, and is thus able to transfer risk associated with an individual transaction in an optimal manner.

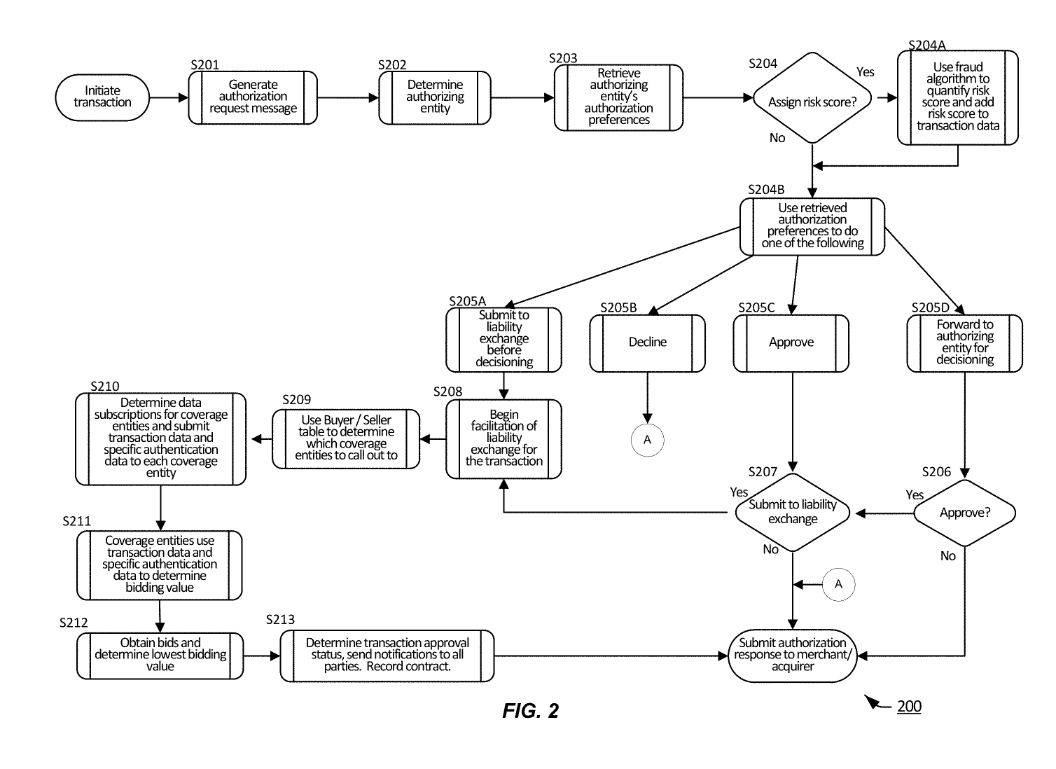

FIG. 2 shows a process flow diagram for a method of facilitating an exchange of liability for an individual transaction according to embodiments of the invention. Reference to FIG. 1 is also made. According to FIG. 2, after a transaction has been initiated by a user 101 with the access device 105 (e.g., using a portable payment device), an authorization request message comprising transaction data such as a transaction amount, merchant ID, and payment account information is generated by the access device 105 or a resource provider computer 110 in step S201. In step S202, the authorization request message is sent to a server computer 130 via the transport computer 120. The server computer in the transaction processing system 130 determines an authorizing entity associated with the transaction data. The transaction data may include an account number including a BIN (bank identification number), and this may be used to identify and route the authorization request message to the appropriate authorizing entity computer 150. In step S203, the server computer in the transaction processing system 130 retrieves the authorizing entity's authorization preferences. In step S204, based on the authorization preferences, the server computer in the transaction processing system 130 determines if a risk score should be assigned to the transaction.

If in step S204 the server computer determines, based on the authorization preferences, that a risk score should be assigned to the transaction, the server computer accesses a fraud algorithm to determine a risk score and add the risk score to transaction data contained in the authorization request message in step S204A before proceeding to step S204B. In step S204B, the server computer in the transaction processing system 130 uses the authorization preferences to determine how to authorize the transaction. The authorization preferences may specify that the server computer in the transaction processing system 130 should either: a) submit the transaction to a liability exchange in step S205A before deciding to authorize, b) decline the transaction in step S205B, c) approve the transaction in step 205C, or d) forward the transaction to the authorizing entity in step S205D.

According to step S205A, the transaction is sent to an authentication hub 136 where a facilitation of an exchange of liability for the transaction begins (S208). According to step S205B, the transaction is declined and an authorization response message is sent to the access device 105 via the resource provider computer 110 and the transport computer 120. According to step S205C, the server computer in the transaction processing system 130 approves the transaction and then determines, based on the authorization preferences, if the transaction should be submitted to an exchange of liability for the transaction. If the server computer 130 in the transaction processing system 130 determines based on the authorization preferences that the transaction should be submitted to a liability exchange, then the transaction may be sent to the authentication hub 136 where an exchange of liability may be facilitated in step S208. Otherwise, an authorization response message containing the indication of approval is sent to the access device 15 via the resource provider computer 110 and the transport computer 120. According to step S205D, the server computer forwards the transaction to the authorizing entity computer 150. The authorizing entity computer 150 then determines whether to approve or decline the transaction in step S206. If the authorizing entity computer 150 approves of the transaction, then the authorization entity computer 150 can determine, based on the authorization preferences, if the transaction should submitted to a liability exchange in step S207. If the server computer in the transaction processing system 130 determines, based on the authorization preferences, that the transaction should be submitted to a liability exchange, then the transaction may be sent to the authentication hub 136 where an exchange of liability may be facilitated in step S208. Otherwise, an authorization response message containing the indication of approval is sent to the access device 105 via the resource provider computer 110 and the transport computer 170. If the authorizing entity computer 150 determines that the transaction is declined in step S206, then an authorization response message comprising an indication of decline is generated and submitted to the access device 105 via the resource provider computer 110 and the transport computer 170.

In step S208, the server computer begins the facilitation of an exchange of liability for the transaction between the authorizing entity computer 150 and coverage entities 141, 142, 143, 144 connected to the authentication hub 136. In step S209, the server computer in the transaction processing system 130 uses a buyer/seller table stored in an authentication participant database 130 to determine which coverage entities to identify for potentially covering the transaction. For example, the server computer in the transaction processing system 130 may determine from the buyer/seller table that there are four coverage entities that are willing to provide coverage for the transaction to the authorizing entity since the transaction is above $500 and has a risk score below 50.

In step S210, the server computer in the transaction processing system 130 determines data subscriptions for each coverage entity 141, 142, 143, 144 willing to provide coverage for the transaction to the authorizing entity operating the authorizing entity computer 150. The data subscriptions are then used to provide the transaction data and specific authentication data to each coverage entity 141, 142, 143, 144. For example, the server computer in the transaction processing system 130 may determine based on the data subscriptions that a first coverage entity should receive a fraud profile for the merchant associated with the transaction and may determine that a second coverage entity should receive spending habits of the user attempting to conduct the transaction.

Various authentication data can be used in embodiments of the invention. Such authentication data may any data which may provide an indication of transactional fraud. Examples of authentication data include fraud profiles of merchants or users, device data from a user's payment device (e.g., an IP address, browser type or history, cryptograms, digital signatures, etc.), biometrics or signatures from the user, spending patterns or spending histories of the user, transactional histories of the resource provider (e.g., merchants), etc.

In step S211, the coverage entities 141, 142, 143, 144 receive the transaction data and specific authentication data and uses the transaction data specific authentication data to each determine a bidding value for the transaction. For example, a first coverage entity may determine based on the transaction data and specific authentication data that it receives that it is willing to provide liability coverage for the transaction at a price of $15 and a second coverage entity may determine based on the transaction data and specific authentication data that it receives that it is willing to provide liability coverage for the transaction at a price of $10. The bidding values are then sent to the server computer in the transaction processing system 130.

In step S212, the server computer in the transaction processing system 130 receives each bidding value from each coverage entity and determines a lowest bidding value. The lowest bidding value and coverage entity associated with the lowest bidding value may then be linked to the transaction. Although the lowest bid is used as a criteria for selecting a particular coverage entity in this example, in other embodiments, other criteria may be used. Examples of such criteria may include the reliability and/or reputation of the various coverage entities, in addition to the bidding values provided by those coverage entities.

In step S213, the transaction approval status is determined by the server computer in the transaction processing system 130 based on the result of the liability exchange and authorization preferences and notifications are sent to the involved parties before a contract is recorded. For example, the authorization preferences may specify that the transaction should be authorized if the lowest bidding value is less than 10% of the transaction amount. A lowest bidding value of $40 for a $500 transaction may be determined, and the transaction may be approved and the resulting contract between the authorizing entity and coverage entity involved may be recorded. An authorization response containing the approval result may be sent to the access device 105 via the resource provider computer 110 and the transport computer 170 to complete the process.

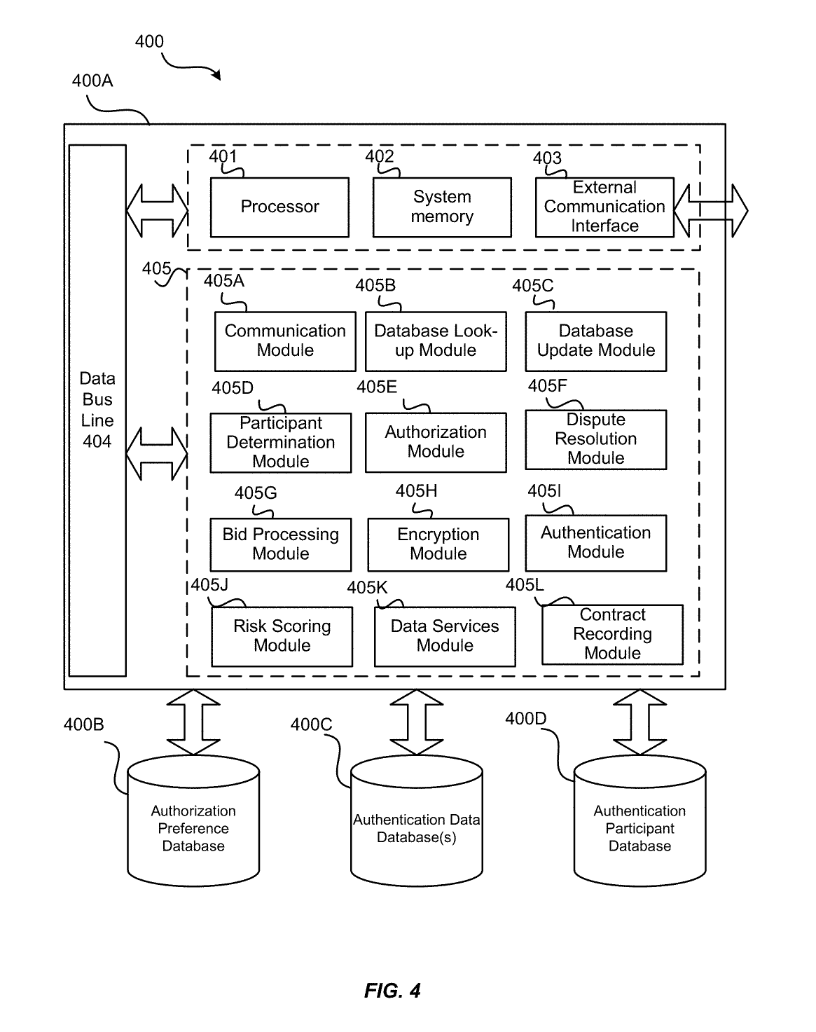

FIG. 4 shows a diagram of a server computer such as a server computer of a transaction processing system 130. Server computer 400A may comprise processor 401 for executing commands and instructions, which may be coupled to system memory 402 and an external communication interface 403. System memory 402 can be implemented using any combination of any number of non-volatile memories (e.g., flash memory) and volatile memories (e.g., DRAM, SRAM), or any other non-transitory storage medium, or a combination thereof. External communication interface 403 may be an interface used to connect server computer 400A to a wide area network such as the internet or any network over which messages can be sent and received by server computer 400A. Processor 401 may further be operatively coupled to a computer-readable medium 405 storing modules and methods executable by processor 401.

Computer-readable medium 405 may comprise a number of software modules including communication module 405A, database look-up module 405B, database update module 405C, participant determination module 405D, authorization module 405E, dispute resolution module 405F, bid processing module 405G, encryption module 405H, authentication module 405I, risk scoring module 405J, data services module 405K, and contract recording module 405L.

Communication module 405A may comprise code that causes processor 401 to generate messages, forward messages, reformat messages, and/or otherwise communicate with other entities. Database look-up module 405 may comprise code for looking up data in a database. Such data may be accessed when performing a task. The database may be, for example, authorization preference database 400B, authentication data database(s) 400C, and/or authentication participant database 400D. Authorization preference database 400B may comprise authorization preferences of an authorizing entity. Authentication data database(s) 400C may comprise authentication data used by server computer 400A to assess the risk of an individual transaction. Authentication participant database 400D may comprise data regarding an authentication participant. Such data may include conditions or logic specifying when an authentication participant may participate in an exchange of liability for an individual transaction. Database update module 405C may comprise code for updating any of the above databases.

Participant determination module 405D may comprise code for determining entities which may be involved in the exchange of liability coverage for an individual transaction. An entity may be a specific authorizing entity associated with the transaction or a coverage entity willing to provide coverage for the transaction based on a table of authentication participant database 400D.

Authorization module 405E may comprise code for authorizing a transaction based on authorization preferences retrieved from authorization preference database 400B. Authorization module 405E may further comprise code for processing and manipulating authorization request messages as well as processing and manipulating authorization response messages.

Dispute resolution module 405F may comprise code for receiving, processing, and resolving a dispute, such as a dispute over an indication of fraud for a transaction and the liable parties involved, and code for facilitating an allocation of funds based on a resolution of the dispute. Bid processing module 405G may comprise code for requesting, receiving, and processing bids from coverage entities regarding an exchange of liability for an individual transaction and code for determining a lowest bidding value from a plurality of received bids.

Encryption module 405H may include any suitable encryption algorithms to encrypt data in embodiments of the invention. Suitable data encryption algortihms may include DES, triple DES, AES, etc. It may also store encryption keys that can be used with such encryption algorithms. The encryption module 405H may utilize symmetric or asymmetric encryption techniques to encrypt and/or verify data.

Authentication module 405I may comprise code for authenticating a transaction using data from authentication data database(s) 400C or from a provider of authentication data in communication with server computer 400A. Risk scoring module 405J may comprise code for determining a risk score for an individual transaction based on authentication data such as authentication data from authentication data database(s) 400C. Data services module 405K may comprise code for receiving, managing, and sending specific authentication data such as specific authentication data subscribed to by a coverage entity. Contract recording module 405L may comprise code for recording a contract between authentication participants such as a contract between an authorizing entity that purchases liability coverage and a coverage entity supplying the liability coverage.

Some entities or components described herein may be associated with or operate one or more computer apparatuses to facilitate the functions described herein. Some of the entities or components described herein, including any server or database, may use any suitable number of subsystems to facilitate the functions.

Examples of such subsystems or components can be interconnected via a system bus. Additional subsystems such as a printer, keyboard, fixed disk (or other memory comprising computer readable media), monitor, which is coupled to display adapter, and others are shown. Peripherals and input/output (I/O) devices, which couple to I/O controller (which can be a processor or other suitable controller), can be connected to the computer system by any number of means known in the art, such as serial port. For example, serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer readable medium.

Embodiments of the invention provide for a number of advantages. For example, embodiments of the invention allow for an authorizing entity computer to authorize a higher volume of authentic transactions over prior authorization and authentication systems as the risk associated with a certain transaction can be shifted to a coverage entity that is willing to accept liability. Furthermore, embodiments of the invention allow an authorizing entity to optimize its authorization process and incur minimal losses as the risk for each individual transaction is evaluated by a plurality of competing coverage entities based on a plurality of disparate authentication data. An authorizing entity is able to select the most favorable coverage policy based on such factors as lowest bidding value, and is thus able to transfer risk associated with an individual transaction in an optimal manner. All of this can be performed during the processing of a single authorization request message and a single authorization response message. The determination of authorization and the determination of shifting coverage can be place in less than 2 minutes, 1 minutes, 30 seconds, or even 5 seconds.

Messages between the computers, networks, and devices described herein may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

It should be understood that the present invention as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
a) receiving, by a server computer, an authorization request message for a transaction from an access device;
b) determining, by the server computer, a coverage entity from a plurality of coverage entities for the transaction, the plurality of coverage entities available to provide coverage for the transaction;
c) linking, by the server computer, the coverage entity to the transaction; and
d) transmitting, an authorization response message, by the server computer, to the access device.

2. The method of claim 1, further comprising:
e) transmitting the authorization request message to an authorization computer; and
f) receiving the authorization response message from the authorization computer.

3. The method of claim 2, wherein steps b) and c) occur after step d).

4. The method of claim 1, wherein steps a)-d) occur in order.

5. The method of claim 1 wherein the method further comprises:
querying a database for authorization entity preferences relating to the use of a coverage entity to cover the transaction.

6. The method of claim 1 wherein the coverage entity is determined based on bidding values received from the plurality of coverage entities available to provide coverage for the transaction.

7. The method of claim 1 wherein the plurality of coverage entities available to provide coverage for the transaction are coverage entities linked to conditions for providing coverage in a database table.

8. The method of claim 6 wherein the bidding values are based on an assessment of authentication data received by the plurality of coverage entities.

9. The method of claim 8 wherein each coverage entity in the plurality of coverage entities receives different authentication data.

10. The method of claim 1 further comprising determining a risk score for the transaction.

11. A server computer comprising:
a processor; and
a computer readable medium coupled to the processor, the computer readable medium comprising code, executable by the processor to implement a method comprising:
a) receiving, by a server computer, an authorization request message for a transaction from an access device;
b) determining, by the server computer, a coverage entity from a plurality of coverage entities for the transaction, the plurality of coverage entities available to provide coverage for the transaction;
c) linking, by the server computer, the coverage entity to the transaction; and
d) transmitting, an authorization response message, by the server computer, to the access device.

12. The server computer of claim 11 wherein the method further comprises:
e) transmitting the authorization request message to an authorization computer; and
f) receiving the authorization response message from the authorization computer.

13. The server computer of claim 11 wherein steps b) and c) of the method occur after step d).

14. The server computer of claim 11 wherein steps a)-d) of the method occur in order.

15. The server computer of claim 11 wherein the method further comprises: querying a database for authorization entity preferences relating to the use of a coverage entity to cover the transaction.

16. The server computer of claim 11 wherein the coverage entity is determined based on bidding values received from the plurality of coverage entities available to provide coverage for the transaction.

17. The server computer of claim 11 wherein the plurality of coverage entities available to provide coverage for the transaction are coverage entities linked to conditions for providing coverage in a database table.

18. The server computer of claim 16 wherein the bidding values are based on an assessment of authentication data received by the plurality of coverage entities.

19. The server computer of claim 18 wherein each coverage entity in the plurality of coverage entities receives different authentication data.

20. The server computer of claim 11 wherein the method further comprises determining a risk score for the transaction.
